(19) United States
(12) Patent Application Publication
(10) Pub. No.: US 2011/0215606 A1
(43) Pub. Date: Sep. 8, 2011

(54) CONSOLE LID FRICTION HINGE

(75) Inventor: Alpesh Trivedi, Northville, MI (US)

(73) Assignee: NISSAN TECHNICAL CENTER NORTH AMERICA, INC., Farmington Hills, MI (US)

(21) Appl. No.: 12/719,303

(22) Filed: Mar. 8, 2010

(51) Int. Cl. B60N 3/00; E05F 3/20

(52) U.S. Cl. 296/24.34; 16/278

(57) ABSTRACT

Embodiments of vehicle consoles and hinges for vehicle consoles are disclosed herein. One embodiment of a hinge for a vehicle console has a fixed component attached to the base structure of the console, a movable component attached to the lid of the console and a shaft connecting the fixed component to the movable component. A spacer is positioned on the shaft between and in contact with at least a portion of both the fixed and movable components and a securing member is positioned on the shaft to apply pressure against at least one of the fixed component and the movable component to produce friction between the movable component and the spacer and to resist rotational movement of the lid about an axis of the shaft.

### FIELD OF THE INVENTION

The present invention relates to the field of vehicle consoles and lid hinge mechanisms for vehicle consoles.

### BACKGROUND

Automotive vehicles are often equipped with a center console positioned between individual front driver and passenger seats and sometimes among the rear seats. Center consoles are provided primarily for storage purposes and typically include a pivotally movable lid that opens up into one or more storage bins, which are usually sufficiently large to house music CD's, maps, keys and other items. The pivotally movable lid is attached to the storage bin via a hinge.

The consoles, particularly ones located between the driver and passenger seats, can be located such that it is awkward for a driver or passenger to open the lid and move it to its fully opened position. If the lid is unlatched and not moved to the fully opened position, the lid can fall back down and relatch. If the lid is in the fully opened position, normal operation of the vehicle may cause the lid to slam closed due to braking or hitting of a bump, for example. Furthermore, lids can tend to vibrate when in the fully opened position due to operation of the vehicle, causing undesirable noise in the passenger compartment.

### SUMMARY

Embodiments of vehicle consoles and hinges for vehicle consoles are disclosed herein. One embodiment of a hinge for a vehicle console having a lid and a base structure comprises a fixed component attached to the base structure, a movable component attached to the lid, a shaft connecting the fixed component to the movable component, a spacer on the shaft positioned between and in contact with at least a portion of both the fixed and movable components and a securing member positioned on the shaft to apply pressure against at least one of the fixed component and the movable component to produce friction between the movable component and the spacer and to resist rotational movement of the lid about an axis of the shaft.

An embodiment of a vehicle console disclosed herein comprises a base structure defining a cavity and having an opening permitting access to the cavity, a lid having a surface area sufficient to cover at least a portion of the opening when the lid is in a closed position, and a hinge connected between the base structure and an edge of the lid and configured to allow rotational movement of the lid between the closed position and an open position, The hinge comprises a movable component comprised of first and second hinge arms coupled to the lid with the first hinge arm proximate a first side edge of the lid and the second hinge arm proximate a second opposing side edge of the lid, a fixed portion connected to the base structure and comprising two mounting members, a shaft connecting the movable component to the fixed portion, the first and second hinge arms being spaced apart along the shaft and the two mounting members being spaced apart along the shaft, spacers mounted on the shaft and positioned such that at least one spacer is between and in contact with an end of one hinge arm and an adjacent one of the two mounting members and a securing member mounted on the shaft applying pressure against at least one of the one hinge arm and the adjacent one of the two mounting members and producing sufficient friction between the at least one spacer and the one hinge arm to resist rotational movement of the lid about an axis of the shaft.

### BRIEF DESCRIPTION OF THE DRAWINGS

The description herein makes reference to the accompanying drawings wherein like reference numerals refer to like parts throughout the several views, and wherein:

FIG. 1 is a perspective view of a vehicle console according to one embodiment of the invention with a lid in a closed position;

FIG. 2 is a perspective view of the vehicle console in FIG. 1 with the lid in an opened position;

FIG. 3 is a perspective view of an embodiment of a hinge and a lid according to an embodiment of the invention;

FIG. 4 is a perspective view of the hinge in FIG. 3;

FIG. 5 is a profile view of the hinge in FIG. 4;

FIG. 6 is a cross-sectional view of FIG. 5 along line A-A;

FIG. 7 is an enlarged partial view of one end of the hinge in FIG. 6; and

FIG. 8 is an enlarged partial view of an opposite end of the hinge in FIG. 6.

### DETAILED DESCRIPTION

A vehicle occupant opens the lid of a console typically by pulling or pushing up on a latch to release the lid. This may occur while the vehicle is stopped or moving. It is desired to provide a lid with a hinge having sufficient torsion to maintain the lid in an open position after the occupant unlatches the lid. It is also desired for the lid to remain in the open position after the occupant moves the lid any rotational distance other than to a closed position. This prevents the lid from falling back to its closed and latched position when the occupant removes his or her hand. If the occupant is driving, the driver does not have to move the lid to the fully opened position to prevent the lid from falling closed and relatching.

In order to prevent the lid from falling back to the closed position from any open position, the hinge must maintain resistance at all times such that force sufficient to overcome the resistance of the hinge is required to close the lid. This prevents the lid from slamming closed if, for example, the vehicle brakes are suddenly applied or the vehicle moves in reverse. In the event that the lid is biased to an open position, this same resistance in the hinge can dampen movement of the lid so that oscillations or noises that might otherwise occur when the lid reaches a hard stop at a fully open position are eliminated.

Console lids can also be used as work benches in vehicles. For example, a lid can be configured to slide outward toward the vehicle dashboard to act as a work surface that is better positioned for the driver or passenger to use. The work surface can support, for example, a lap top computer for use by a driver when the vehicle is parked so that the driver does not have to turn sideways toward to center console to view the computer. The lids of these consoles typically weigh more than a conventional lid due to the work surface extension. This additional weight can amplify the conditions noted above.

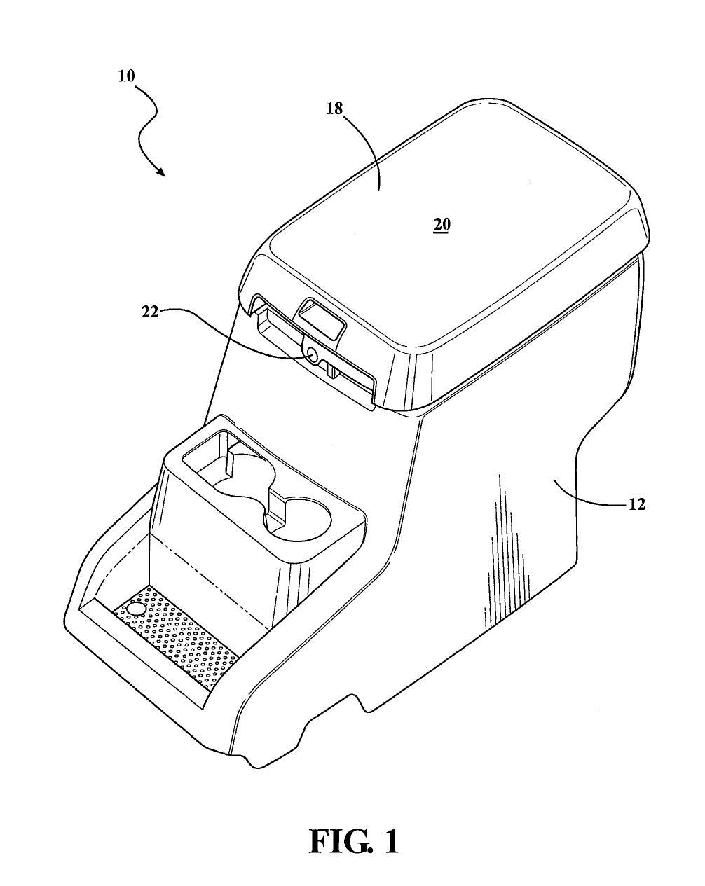

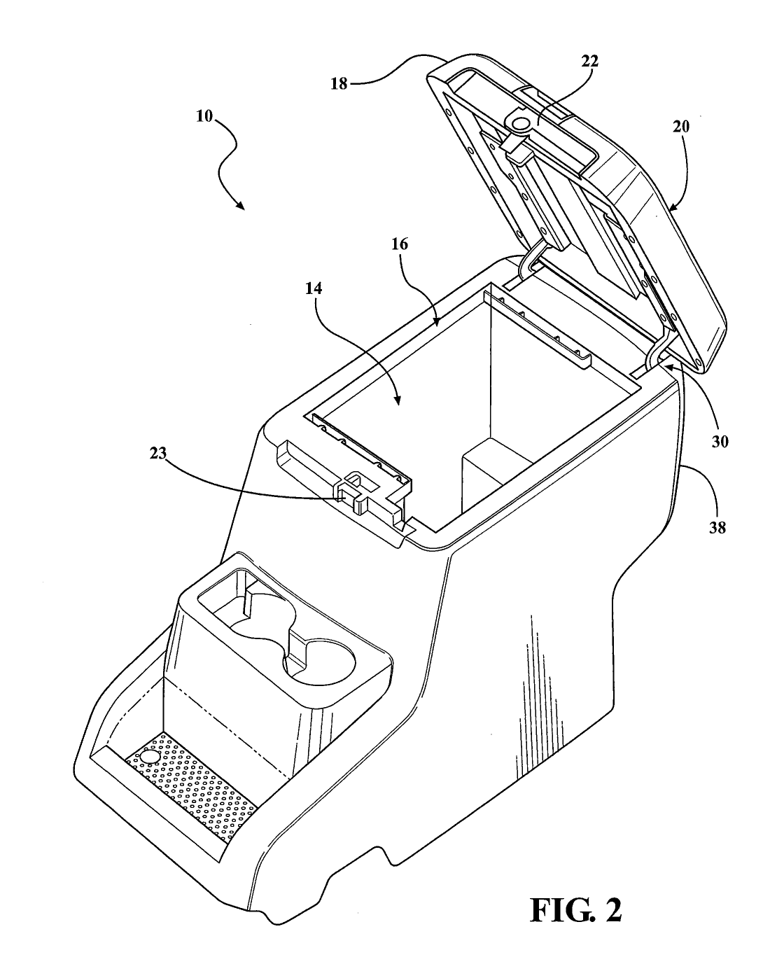

Referring first to FIGS. 1 and 2, a vehicle console 10 is illustrated. The vehicle console includes a base structure 12 defining a cavity 14 and having an opening 16 permitting access to the cavity 14. A lid 18 is attached to the base structure 12 and moves between an open position permitting access to the cavity 14 and a closed position. The lid 14 has a surface area 20 sufficient to cover at least a portion of the opening 16 to the cavity 14 when the lid 18 is in the closed position, shown in FIG. 1.

The console 10 in FIG. 1 is provided by way of illustration. For example, the console 10 can have more than one cavity 14. As is typical, one or more cup holders can be provided either integral with the console 10 or extending from the console 10. Lid 18 of console 10 generally has a latch 22 and a corresponding engaging portion 23 on the base structure 12 so as to secure items in the cavity 14 or cavities. The latch 22 disengages from the engaging portion 23 so as to allow access to the cavity 14 or cavities. The latch 22 can be of any conventional design. Base structure 12 generally comprises a plastic material as known to those skilled in the art of vehicle interior trim design.

FIG. 2 illustrates the lid 18 in an opened position. Lid 18 undergoes rotational movement between the closed and open positions with respect to base structure 12 through the use of a hinge 30.

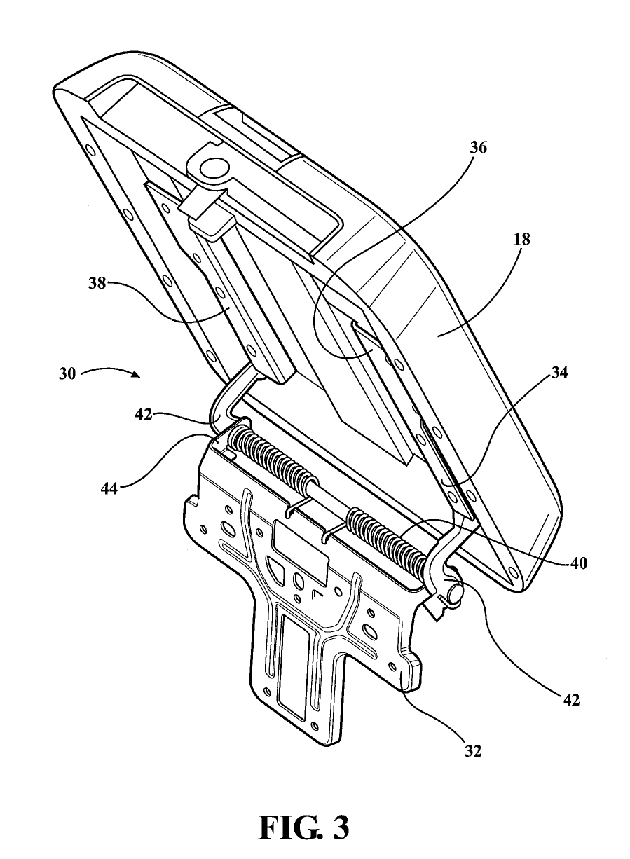

FIGS. 3-8 illustrate embodiments of the hinge 30. The hinge 30 can have a fixed component 32 that attaches to the base structure 12. As shown in FIG. 2, the fixed component 32 is at least partially concealed and connected to a rear portion 38 of base structure 12 with respect to the travel direction of the vehicle. The fixed component 32 can be concealed between a wall of the cavity 14 and by the rear portion 38 of the base structure 12 so as to form a relatively uniform interior and exterior appearance of the console 10. The fixed component 32 can be connected to the base structure 12 by means of fasteners, welding, and any other means known to those skilled in the art.

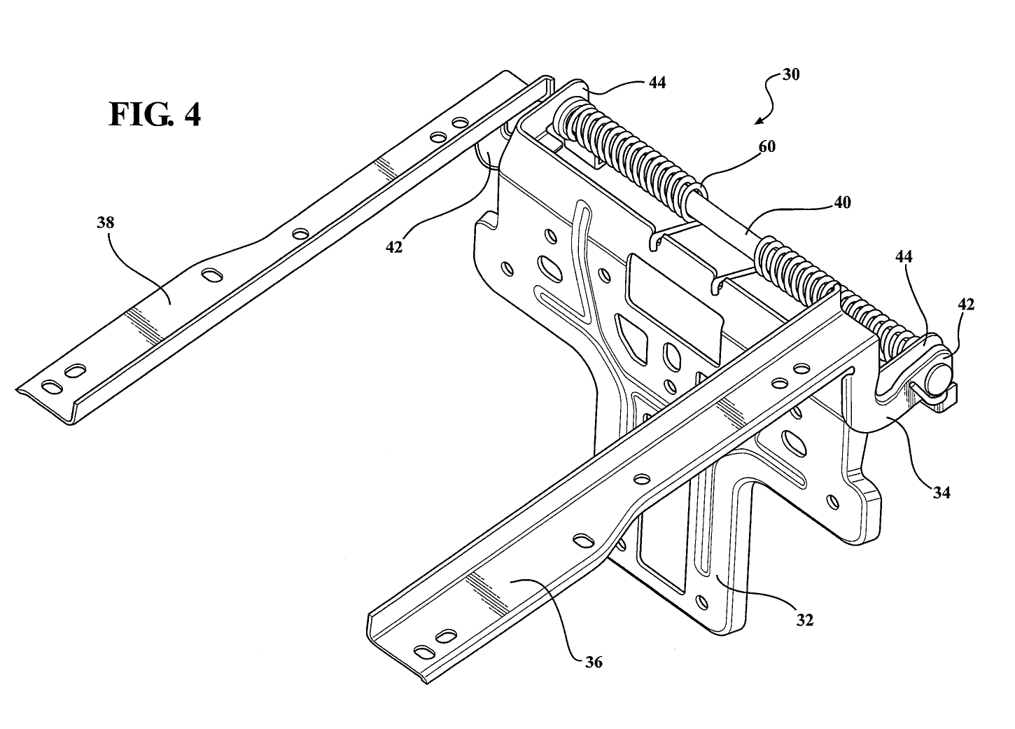

A movable component 34 can be attached to the lid 18 so that the movable component 34 supports the lid 18. In the disclosed embodiment of FIGS. 3 and 4, movable component 34 comprises first and second hinge arms 36, 38 extending in a direction away from the fixed component 32 and along at least a portion of first and second side edges of the lid 18, respectively, as seen in FIG. 3. The movable component 34 can be attached to the underside of the lid 18 by means of fasteners, welding, and any other means known to those skilled in the art. The fixed component 32 and movable component 34 are generally made of steel or other material capable of withstanding the stresses associated with frequent opening and closing movements. Although only one type of fixed component 32 and movable component 34 is shown by example, various shapes, sizes and designs as known to those skilled in the art can be used with embodiments of the invention when provided with the teachings herein.

The movable component 34 of hinge 30 is pivotable with respect to the fixed component 32 so as to move the lid 18 between the closed position and the open position. While the illustrated embodiment shows a configuration where the pivoting point of hinge 30 is arranged in a rear position of console 10 with respect to the forward vehicle travel direction, this is not necessary. Hinge 30 can be arranged so that the pivoting point for the opening and closing of lid 18 is in any orientation with respect to opening 16.

The movable component 34 can be pivotable about a shaft 40, which can connect the fixed component 32 to the movable component 34. As seen in FIGS. 3 and 4, ends 42 of the first and second hinge arms 36, 38 are each mounted on the shaft such that the ends 42 are spaced along the shaft 40. The spacing along the shaft 40 can be determined by the width of the lid 18 as shown in FIG. 3, as the first hinge arm 36 extends from proximate the first side edge of the lid 18 and the second hinge arm 38 extends proximate the second opposing side edge of the lid 18.

The fixed portion 32 can comprise mounting members 44 for coupling the fixed portion 32 to the shaft 40. Two mounting members 44 are shown in the figures for illustration purposes. The fixed portion 32 can extend unitarily between the two mounting members 44 as shown, although this is not required. Any number of mounting members can be incorporated as desired or required. The mounting members 44 are spaced apart on the shaft 40 as shown in FIG. 4. The mounting members 44 are located along the shaft 40 on the inside of the hinge arms 36, 38, but this is not required. The hinge arms 36, 38 can be mounted on the inside of the mounting members 44 along the shaft 40 as desired.

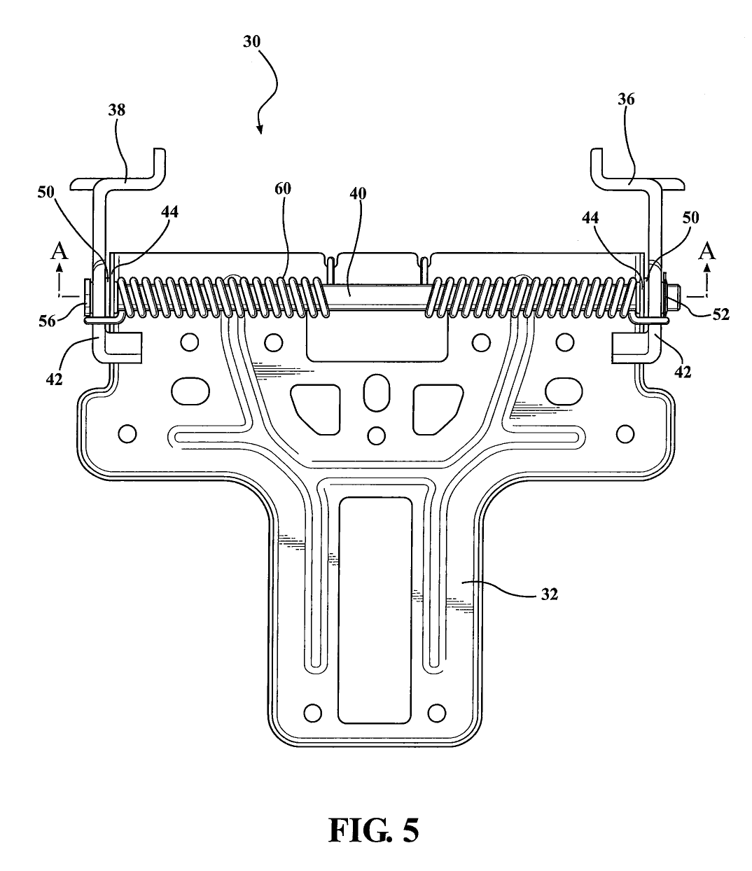

As best seen in FIGS. 5-8, a spacer 50 is positioned on the shaft 40 between the fixed component 32 and the movable component 34, with the spacer 50 in contact with at least a portion of both the fixed and movable components 32, 34. More than one spacer 50 can be used in the hinge 30. The number of spacers 50 is dependent on the number of mounting locations of each of the movable component 34 and the fixed component 32. For example, the figures illustrate the use of two spacers 50.

A securing member 52 can be positioned on the shaft 40 in order to apply pressure against the movable component 34, which produces friction between the movable component 34 and the spacer 50 and resists rotational movement of the lid 18 about an axis of the shaft 40. Alternatively, the securing member may apply pressure against the fixed component 32 in the event that the positions of the fixed and movable components 32, 34 along the shaft 40 are reversed. The friction between the spacer 50 and the movable component 34 can prevent the lid 18 from falling closed when it is only partially opened. This friction can also prevent the lid 18 from slamming closed when it is in a fully opened position. In the event that the lid 18 is biased to an open position, this friction can also dampen movement of the lid 18 so that oscillations or noises that might otherwise occur when the lid 18 reaches a hard stop at the fully open position are eliminated.

The spacer 50 can be made of a high lubricity material to create sufficient friction while at the same time enabling smooth and repeatable movement of the movable component 34 when the securing member 52 is positioned on the shaft 40. A non-limiting example of a high lubricity material is a plastic such as nylon. The spacer 50 can be annular in shape, for example, similar to a washer. The spacer 50 can also be configured such that the fixed component 32 and movable component 34 each contact the spacer 50 on respective surfaces 53 that are continuously annular about an axis of the shaft 40. Other spacer configurations as desired or required by those skilled in the art can be used with embodiments of the invention when provided with the teachings herein.

As best seen in FIGS. 7 and 8, the spacer 50 can include annular extensions 54 having outer diameters that are less than an outer diameter of a portion of the spacer 50 located between the fixed and movable components 32, 34, or between the end 42 of the hinge arms 36, 38 and the mounting member 44 of the fixed component 32. The annular extensions 54 of the spacer 50 can pass through respective apertures in the fixed and movable components 32, 34 such that the annular extensions 54 separate the fixed and movable components 32, 34, or the end 42 of the hinge arms 36, 38 and the mounting member 44 of the fixed component 32, from at least a portion of the shaft 40.

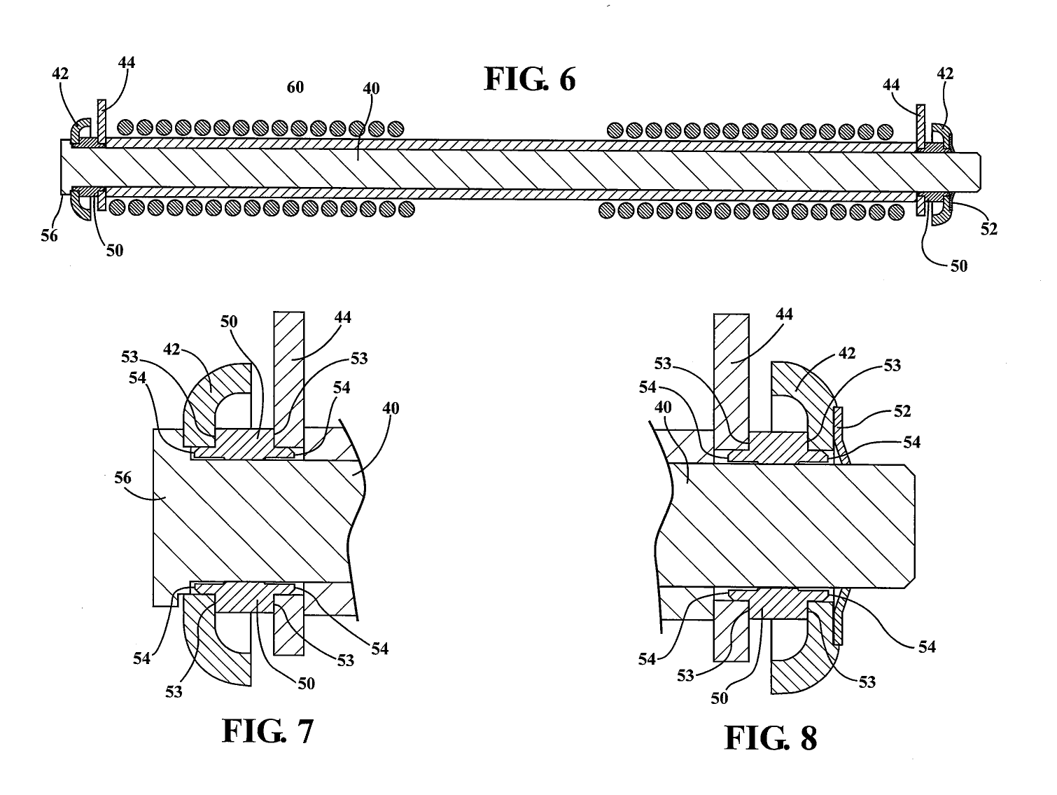

The securing member 52 is positioned on the shaft 40 such that the securing member 52 applies an axial compressive force on the movable component 34 ranging from about 2170 N to about 2270 N. This axial compressive force produces the friction between the spacer 50 and the movable component 34. The securing member 52 may be a single retention washer (as shown in FIGS. 6-8) that is placed on one end of the shaft 40, where the opposite end of the shaft 40 has a widened portion 56, the widened portion 56 having a diameter larger than apertures in the ends 42 of the hinge arms 36, 38. However, the securing member 52 can also comprise a retention washer on each end of the shaft 40 with the axial compressive force being applied to the ends 42 of the hinge arms 36, 38 in opposing directions. The widened portion 56 is illustrated in FIG. 7 with a retention washer 52 or nut illustrated at the opposite end in FIG. 8. The force can be applied with a hydraulic press, as a non-limiting example. Other means of maintaining the axial compressive force on the spacers 50 and at least one of the fixed and movable components 32, 34 known to those skilled in the art can be used with embodiments of the invention when provided with the teachings herein.

Embodiments of the hinge 30 and console 10 disclosed herein can also comprise a biasing member 60 that biases the lid 18 to an open position. The biasing member 60 can be configured to be tensioned when the lid 18 is in a closed position and to be tensioned when the lid 18 is in an open position, with the tension of the biasing member 60 in the closed position being greater than the tension of the biasing member 60 in the open position. As illustrated in FIGS. 3-6, a spring can be used as the biasing member 60. However, other biasing members 60 known to those skilled in the art can be used with embodiments of the invention when provided with the teachings herein.

The biasing member 60 can be configured to resist movement of the lid 18 about the axis of the shaft 40 when a force less than or equal to 0.4 G is exerted on the lid 18. Of course, it is also contemplated that the friction between the spacer 50 and the movable component 34 can also resist this movement if a biasing member is not used.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A hinge for a vehicle console having a lid and a base structure, the hinge comprising:
a fixed component attached to the base structure;
a movable component attached to the lid;
a shaft connecting the fixed component to the movable component;
a spacer on the shaft positioned between and in contact with at least a portion of both the fixed and movable components; and
a securing member positioned on the shaft to apply pressure against at least one of the fixed component and the movable component to produce friction between the movable component and the spacer and to resist rotational movement of the lid about an axis of the shaft.

2. The hinge of claim 1 wherein the spacer is made of a high lubricity material.

3. The hinge of claim 2, wherein the high lubricity material is nylon.

4. The hinge of claim 1, further comprising a biasing member configured to be tensioned when the lid is in a closed position and to be tensioned when the lid is in an open position, the tension of the biasing member in the closed position being greater than the tension of the biasing member in the open position.

5. The hinge of claim 4, wherein the biasing member is configured resist movement of the lid about the axis of the shaft when a force less than or equal to 0.4 G is exerted on the lid.

6. The hinge of claim 1, wherein the securing member applies an axial compressive force on the at least one of the fixed component and the movable component ranging from about 2170 N to about 2270 N.

7. The hinge of claim 1, wherein the shaft has a widened portion at one end and the securing member is a retention washer mounted on the shaft opposite the widened portion.

8. The hinge of claim 1, wherein the movable component comprises first and second hinge aims spaced apart along the shaft and extending substantially parallel to each other.

9. The hinge of claim 1, wherein the spacer includes annular extensions having outer diameters that are less than an outer diameter of a portion of the spacer located between the fixed and movable components, the annular extensions of the spacer passing through respective apertures in the fixed and movable components such that the annular extensions separate the fixed and movable components from the shaft.

10. The hinge of claim 1, wherein the fixed and movable components each contact the spacer on respective surfaces that are continuously annular about the axis of the shaft.

11. A vehicle console comprising:
a base structure defining a cavity and having an opening permitting access to the cavity;
a lid having a surface area sufficient to cover at least a portion of the opening when the lid is in a closed position;
a hinge connected between the base structure and an edge of the lid and configured to allow rotational movement of the lid between the closed position and an open position, the hinge comprising:
a movable component comprised of first and second hinge aims coupled to the lid with the first hinge arm proximate a first side edge of the lid and the second hinge arm proximate a second opposing side edge of the lid;
a fixed portion connected to the base structure and comprising two mounting members;
a shaft connecting the movable component to the fixed portion, the first and second hinge arms being spaced apart along the shaft and the two mounting members being spaced apart along the shaft;
spacers mounted on the shaft and positioned such that at least one spacer is between and in contact with an end of one hinge arm and an adjacent one of the two mounting members; and
a securing member mounted on the shaft applying pressure against at least one of the one hinge arm and the adjacent one of the two mounting members and producing sufficient friction between the at least one spacer and the one hinge arm to resist rotational movement of the lid about an axis of the shaft.

12. The console of claim 11 wherein the spacers are made of a high lubricity material.

13. The console of claim 12, wherein the high lubricity material is nylon.

14. The console of claim 11, further comprising a biasing member configured to be tensioned when the lid is in the closed position and to be tensioned when the lid is in the open position, the tension of the biasing member in the closed position being greater than the tension of the biasing member in the open position.

15. The console of claim 14, wherein the biasing member is configured to resist movement of the lid about the axis of the shaft when a force less than or equal to 0.4 G is exerted on the lid.

16. The console of claim 11, wherein the securing member applies an axial compressive force on the at least one of the one hinge arm and the adjacent one of the two mounting members ranging from about 2170 N to about 2270 N.

17. The console of claim 11, wherein the shaft has a widened portion at one end and the securing member is a retention washer mounted on the shaft opposite the widened portion.

18. The console of claim 11, wherein the spacers include annular extensions having outer diameters that are less than outer diameters of portions of the spacers located between respective ones of the first and second hinge arms and the two mounting members, the annular extensions of the spacers passing through respective apertures in the first and second hinge arms and the two mounting members such that the annular extensions separate the first and second hinge arms and the two mounting members from the shaft.

19. The console of claim 11, wherein the first and second hinge arms and the two mounting members contact the spacers on respective surfaces that are continuously annular about the axis of the shaft.

20. The console of claim 11, wherein the fixed portion extends unitarily between the two mounting members.
